(19) United States
(12) Patent Application Publication
(10) Pub. No.: US 2026/0003792 A1
(43) Pub. Date: Jan. 1, 2026

(54) Software-Guided Prefetch Throttling based on Memory Region Boundaries

(71) Applicant: Advanced Micro Devices, Inc., Santa Clara, CA (US)

(72) Inventors: Mark Evan Wilkening, Cambridge, MA (US); John Kalamatianos, Arlington, MA (US)

(73) Assignee: Advanced Micro Devices, Inc., Santa Clara, CA (US)

(21) Appl. No.: 18/758,058

(22) Filed: Jun. 28, 2024

(51) Int. Cl. G06F 12/0862

(52) U.S. Cl. CPC G06F 12/0862

(57) ABSTRACT

Systems and techniques for software-guided prefetch throttling based on memory region boundaries are described. In one example, a processor includes a cache system having a cache system and a hardware prefetcher associated with a cache level of the cache system. The hardware prefetcher receives a boundary hint from a workload of an execution unit that accesses the cache level. The hardware prefetcher throttles prefetch requests based on the memory hint being satisfied. The described techniques overcome cache pollution from conventional prefetchers without limiting a prefetcher's ability to identify and respond to stride access patterns.

### BACKGROUND

Processors use prefetching to minimize the delay in accessing memory. For example, prefetchers retrieve data predicted to be used by a workload into a memory source (e.g., cache memory) that is accessible by a processor with increased speed, e.g., in comparison to the memory source from which the data is fetched. However, prefetch predictions are imperfect and often result in unnecessary prefetches that are detrimental to performance. Unnecessary prefetches cause cache pollution and saturate memory access bandwidth.

### BRIEF DESCRIPTION OF THE DRAWINGS

FIG. 1 is a block diagram of a non-limiting example system to implement software-guided prefetch throttling based on memory region boundaries.

FIG. 2 depicts a non-limiting example in which throttling logic uses software-provided boundary hints to throttle prefetch requests issued by a hardware prefetcher of a level one cache.

FIG. 3 depicts another non-limiting example in which throttling logic uses software-provided boundary hints to throttle prefetch requests issued by a hardware prefetcher of a level one cache.

FIG. 4 depicts a procedure in an example implementation of software-guided prefetch throttling based on memory boundary hints.

FIG. 5 depicts a block diagram of a processing system configured to execute one or more applications in accordance with one or more implementations.

### DETAILED DESCRIPTION

### Overview

An example system includes a processor communicatively coupled to a memory system with volatile and non-volatile memory. The processor includes a cache system with multiple cache levels. For example, the cache system includes level one caches and level two caches that are private to respective cores of the processor, and a last level cache that is shared among the multiple cores of the processor. The processor further includes a hardware prefetcher associated with one or each cache level. Broadly, the hardware prefetcher is configured to prefetch data that is predicted to be accessed by a workload from a slower memory source in terms of memory access speed (e.g., the level two cache, the last level cache, the volatile memory, or the non-volatile memory) into the cache.

Many processor workloads include stride access patterns in which a consistent pattern is identifiable in the virtual memory address of the accessed data. For example, a stride access pattern accesses a series of data that occupy every other virtual memory address. Some cache prefetchers are configurable to identify and lock on such stride access patterns to prefetch future memory accesses accurately, thereby improving workload processing. Conventional prefetchers, however, do not have insight into when to stop prefetching data based on the detected stride pattern, resulting in cache pollution until the prefetchers determine that stride access has ceased.

Broadly, cache pollution occurs when the data entering the cache is not accessed by an associated workload before it gets evicted. For example, unnecessary prefetches occur when a prefetcher predicts future data to be accessed by a workload based on a detected stride pattern, but the workload exits or completes the pattern (e.g., an arithmetic loop) before needing the prefetched data. In such scenarios, the cache could experience frequent evictions of needed data, which causes system performance degradation. If repeated for multiple routines within or across workloads, the unnecessary prefetching generates significant traffic in the communication channels between the cache and the lower levels of memory, thereby delaying other access requests. In addition, the unnecessary prefetched data occupies capacity in the cache.

Conventional techniques address cache pollution by throttling prefetch requests using confidence counters. A confidence counter is updated based on correct and incorrect predictions of future memory accesses. Prefetching stops once the confidence counter drops below a threshold value. Such conventional techniques still result in incorrect prefetches when loops are entered at varying locations or when loops have variable counts across invocations. By failing to throttle prefetch requests in these scenarios, conventional throttlers still cause cache pollution that displaces data to be accessed, wastes cache storage, and needlessly uses communication bandwidth. In other scenarios, confidence counter thresholds result in over-throttling for short loops.

In contrast, this document describes throttling logic configured to reduce and/or eliminate unnecessary prefetch requests issued by the hardware prefetcher based on boundary region hints provided by software associated with the workload. Accordingly, the described throttling logic is configured to throttle prefetch requests issued by the hardware prefetcher based on boundary conditions issued by a workload's operation code. The throttling logic sets access boundaries or address ranges on the prefetchable virtual addresses based on the boundary hints. In this way, the hardware prefetcher maintains the flexibility to determine prefetch patterns and their distance but receives boundary hints from the operation code to minimize unnecessary prefetches. The reduction of unnecessary prefetches lowers power consumption and improves cache utilization and hit rate.

In some aspects, the techniques described herein relate to a processor that comprises prefetching circuitry associated with a cache level of a hierarchy of one or more cache levels, the prefetching circuitry configured to receive a boundary hint from a workload of an execution unit that accesses the cache level and throttle prefetch requests based on the boundary hint being satisfied.

In some aspects, the techniques described herein relate to a processor, wherein the accesses of the workload include a stride access pattern.

In some aspects, the techniques described herein relate to a processor, wherein the boundary hint includes a boundary type for a boundary condition of the stride access pattern, a boundary address for the boundary condition, and a target indicator identifying a program counter associated with the stride access pattern.

In some aspects, the techniques described herein relate to a processor, wherein the boundary type includes instructions to allow prefetch requests with a memory address less than the boundary address or greater than the boundary address.

In some aspects, the techniques described herein relate to a processor, wherein the processor further includes a register configured to determine the boundary address based on algorithmic metadata associated with the accesses included in one or more operation codes of the processor.

In some aspects, the techniques described herein relate to a processor, wherein the boundary address is specified as an offset to the program counter.

In some aspects, the techniques described herein relate to a processor, wherein the boundary condition is set before the workload invokes a loop associated with the stride access pattern and cleared after the workload completes the loop.

In some aspects, the techniques described herein relate to a processor, wherein the prefetch requests are throttled in response to a memory address accessed by a prefetch request satisfying the boundary type and the boundary address.

In some aspects, the techniques described herein relate to a processor, wherein the boundary condition is applied to each access instruction of a loop associated with the stride access pattern.

In some aspects, the techniques described herein relate to a processor, wherein the boundary hint includes a boundary type for a boundary condition of the stride access pattern, a variable boundary for the boundary condition based on a value of a loop count associated with the stride access pattern, and an exit indicator indicating a program counter of an exit from a loop associated with the stride access pattern.

In some aspects, the techniques described herein relate to a processor, wherein the boundary condition is set for each loop associated with the loop count.

In some aspects, the techniques described herein relate to a processor, wherein the boundary condition applies to each access instruction until the boundary condition is satisfied.

In some aspects, the techniques described herein relate to a processor, wherein the prefetch requests are throttled in response to a loop count value associated with a memory address accessed by a prefetch request satisfying the boundary type and the variable boundary.

In some aspects, the techniques described herein relate to a system that comprises a processor including a cache system with a cache level that includes prefetching circuitry, the processor configured to execute a workload that accesses the cache level, and send, to the prefetching circuitry, a boundary hint indicating a prefetching boundary condition for prefetch requests associated with the workload.

In some aspects, the techniques described herein relate to a system, wherein the boundary hint is generated from operation code associated with the workload.

In some aspects, the techniques described herein relate to a system, wherein the boundary hint is automatically determined by a compiler when compiling software associated with the workload.

In some aspects, the techniques described herein relate to a system, wherein the accesses of the workload include a stride access pattern.

In some aspects, the techniques described herein relate to a system, wherein the boundary hint includes a boundary type for a boundary condition of the stride access pattern, a boundary address for the boundary condition, and a target indicator identifying a program counter associated with the stride access pattern.

In some aspects, the techniques described herein relate to a system, wherein the boundary hint includes a boundary type for a boundary condition of the stride access pattern, a variable boundary for the boundary condition based on a value of a loop count associated with the stride access pattern, and an exit indicator indicating a program counter of an exit from a loop associated with the stride access pattern.

In some aspects, the techniques described herein relate to a method that comprises receiving, by a hardware prefetcher associated with a cache level of a hierarchy of one or more cache levels, a boundary hint from a workload of an execution unit that accesses the cache level, disabling, by the hardware prefetcher, throttling of prefetch requests responsive to a first memory address of a first prefetch request associated with the workload not satisfying the boundary hint, and enabling, by the hardware prefetcher, the throttling of the prefetch requests responsive to a second memory address of a second prefetch request associated with the workload satisfying the boundary hint.

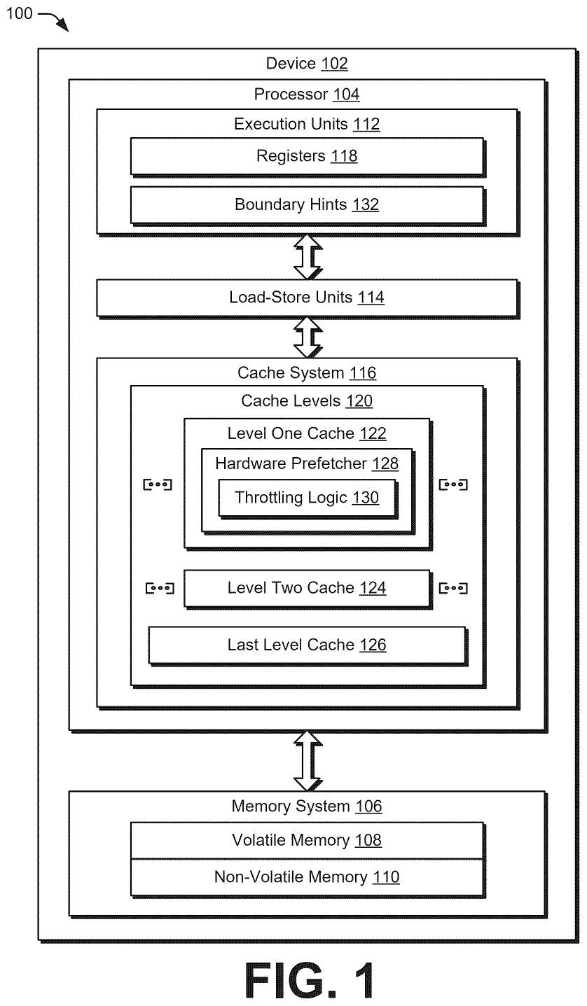

FIG. 1 is a block diagram of a non-limiting example system 100 to implement software-guided prefetch throttling based on memory region boundaries. The system 100 includes a device 102 having a processor 104 and a memory system 106 having volatile memory 108 and non-volatile memory 110. The device 102 is configurable in a variety of ways. Examples of the device 102 include, by way of example and not limitation, computing devices, servers, mobile devices (e.g., wearables, mobile phones, tablets, laptops), processors (e.g., graphics processing units, central processing units, and accelerators), digital signal processors, disk array controllers, hard disk drive host adapters, memory cards, solid-state drives, wireless communications hardware connections, Ethernet hardware connections, switches, bridges, network interface controllers, and other apparatus configurations. It is to be appreciated that in various implementations, the device 102 is configured as any one or more of those devices listed just above and/or a variety of other devices without departing from the spirit or scope of the described techniques.

In accordance with the described techniques, the processor 104 and the memory system 106 are coupled to one another via one or more wired and/or wireless connections. Example wired connections include, but are not limited to, buses (e.g., a data bus), interconnects, traces, and planes. The processor 104 is an electronic circuit that reads, translates, and executes workloads of a program, e.g., an application, operating system, virtual machine, container, and so on. Examples of the processor 104 include, but are not limited to including, central processing units (CPUs), graphics processing units (GPUs), Field Programmable Gate Arrays (FPGAs), Application Specific Integrated Circuits (ASICs), digital signal processors (DSPs), and accelerator devices.

The volatile memory 108 and the non-volatile memory 110 are devices and/or systems used to store information, such as for use by the processor 104. By way of example, the processor 104 includes a memory module (e.g., a Transflash memory module, a single in-line memory module (SIMM), or a dual in-line memory module (DIMM)), and the memory module is a circuit board (e.g., a printed circuit board) on which the volatile memory 108 and the non-volatile memory 110 are mounted. Further, the volatile memory 108 and the non-volatile memory 110 correspond to semiconductor memory, where data is stored within memory cells on one or more integrated circuits.

Broadly, the volatile memory 108 retains data as long as the device 102 is connected to power, and the data is accessible relatively faster than the non-volatile memory 110. Examples of volatile memory 108 include random-access memory (RAM), dynamic random-access memory (DRAM), synchronous dynamic random-access memory (SDRAM), and static random-access memory (SRAM).

The non-volatile memory 110 retains data even after the device 102 is disconnected from power, but is accessible relatively slower than the volatile memory 108. Examples of non-volatile memory include solid state disks (SSD), flash memory, read-only memory (ROM), programmable read-only memory (PROM), erasable programmable read-only memory (EPROM), and electronically erasable programmable read-only memory (EEPROM).

As shown, the processor 104 includes one or more execution units 112, one or more load-store units 114, and a cache system 116 coupled to one another via one or more wired and/or wireless connections. An execution unit 112 is representative of functionality implemented in hardware (e.g., electronic circuitry) of the processor 104 to perform specific types of workloads, such as arithmetic and logic operations. Further, a load-store unit 114 is representative of functionality implemented in the hardware of the processor 104 to perform load operations and store operations as part of a workload. The execution units 112 and the load-store units 114 perform respective operations based on requests received through the execution of software programs, e.g., applications, operating systems, virtual machines, containers, and so on. By way of example, requests are generated and forwarded to the execution units 112 and/or the load-store units 114 by a control unit (not depicted) of the processor 104.

Load requests instruct the load-store units 114 to load data from the cache system 116, the volatile memory 108, and/or the non-volatile memory 110 into registers 118 of the execution units 112. Once loaded into registers 118, requests (e.g., arithmetic and logic requests) are executable by the execution units 112 to perform corresponding operations (e.g., arithmetic and logic operations) on the data. Store requests instruct the load-store units 114 to store data from the registers 118 (e.g., after the data has been processed by the execution units 112) in the cache system 116, the volatile memory 108, and/or the non-volatile memory 110. Load requests and store requests issued by the load-store units 114 as part of executing a runtime program are referred to herein collectively as “access requests.”

As illustrated, the cache system 116 includes multiple cache levels 120, including a level one cache 122, a level two cache 124, and a last level cache 126. By way of example, processor 104 is a multi-core processor, and each respective core includes the level one cache 122 and level two cache 124 that are exclusively used by a respective core. Furthermore, the processor 104 includes the last level cache 126 shared among the multiple cores of the processor 104.

The cache system 116 corresponds to semiconductor memory where data is stored within memory cells on one or more integrated circuits. The higher cache levels (e.g., level one cache 122) are accessible (e.g., for loading and/or storing data) relatively faster than the lower cache levels (e.g., the last level cache 126). Lower cache levels in the hierarchy of cache levels generally have greater memory capacity than higher cache levels. In other implementations, the cache system 116 includes differing numbers of cache levels and different hierarchical structures without departing from the spirit or scope of the described techniques.

The cache system 116 is accessible (e.g., for loading and/or storing data) relatively faster than the memory system 106. The various memory sources of processor 104 are ordered from fastest access speed to slowest access speed in the following order: (1) the level one cache 122, (2) the level two cache 124, (3) the last level cache 126, (4) the volatile memory 108, and (5) the non-volatile memory 110. As a result, a load-store unit 114 executes a load request that includes a memory address by progressively checking the memory sources for the identified data in the aforementioned order. If the data is present in a memory source, the load-store unit 114 loads the data from that memory source into the registers 118, and if not, the load-store unit 114 proceeds to check whether the data is present in the next memory source.

As illustrated in FIG. 1, the level one cache 122 includes a hardware prefetcher 128, which is representative of functionality implemented in the hardware of the processor 104 to prefetch data that is predicted to be used (e.g., in the near future) by a workload of a runtime program. For example, the hardware prefetcher 128 is an electronic circuit that monitors memory access patterns (e.g., stride access patterns) of the workload and predicts which memory addresses are likely to be accessed based on the observed memory access patterns. The hardware prefetcher 128 then issues a prefetch request to fetch data of the predicted memory address from a slower memory source in terms of access speed (e.g., the level two cache 124, the last level cache 126, the volatile memory 108, or the non-volatile memory 110) into the level one cache 122. Examples of the hardware prefetcher 128 include but are not limited to stream prefetchers, sequential prefetchers, stride prefetchers, adjacent-line prefetchers, and spatial prefetchers.

Although not depicted, it is appreciated that the level two cache 124 and the last level cache 126 each include a hardware prefetcher 128 with similar functionality. Additionally or alternatively, the hardware prefetcher 128 associated with the level one cache 122 prefetches data from the volatile memory 108 and/or the non-volatile memory 110 into each of the various cache levels 120 of the cache system 116. Regardless of configuration, the prefetch requests issued by the hardware prefetcher 128 reduce memory access latency and improve overall computer performance by fetching data that is about to be used by the workload to a faster memory source (in terms of memory access speed) in various implementation scenarios.

However, aggressive prefetching protocols often worsen processor performance, causing cache pollution and saturating memory access bandwidth. As described above, prefetch requests cause cache pollution when the prefetch requests evict data from the level one cache 122 to make room for prefetched data, and the evicted data is used by the workload soon thereafter. Unnecessary prefetch requests saturate memory access bandwidth by occupying communication channels between the various memory sources, thereby delaying other access requests.

Throttling logic 130 is implemented in the hardware prefetcher 128 to reduce and/or eliminate the issuing of inaccurate or untimely prefetch requests by the hardware prefetcher 128. Some other conventional throttlers use a software routine in the execution unit 112 to extract dynamic runtime information from hardware counters in the execution unit 112. Such software routines then may configure prefetchers to stop issuing prefetches entirely. Accordingly, these software techniques may over-throttle hardware prefetchers, leading to system latency.

To alleviate the disadvantages of these and other conventional throttling techniques, the throttling logic 130 of the described techniques is configured to throttle prefetch requests issued by the hardware prefetcher 128 based on memory region boundaries for memory addresses that can be prefetched. To do so, the throttling logic 130 uses boundary hints 132 provided by or sent by software and/or firmware in the execution units 112. The boundary hints 132 are generated by a software developer or by a compiler for memory instructions with known access patterns at compile time for software run by the execution units 112. In this way, the boundary hints 132 assist the hardware prefetcher 128 in avoiding excess prefetches (e.g., extending outside the memory region boundaries indicated in the boundary hints 132) while enabling the hardware prefetcher 128 to maintain full flexibility in determining prefetch patterns and issuing bandwidth decisions. In some implementations, the hardware prefetcher 128 overrides a confidence or counter threshold based on the boundary hints 132.

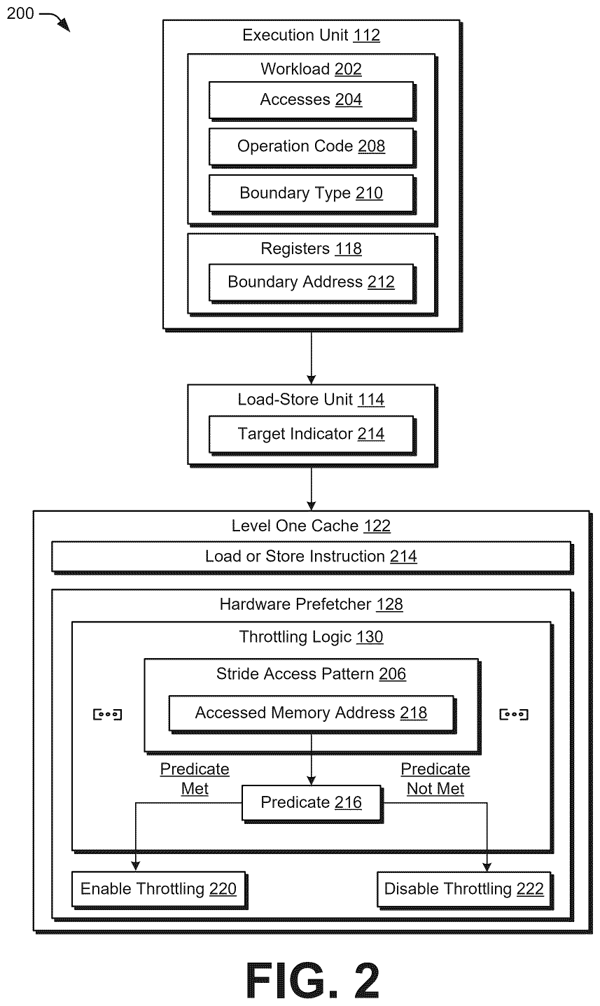

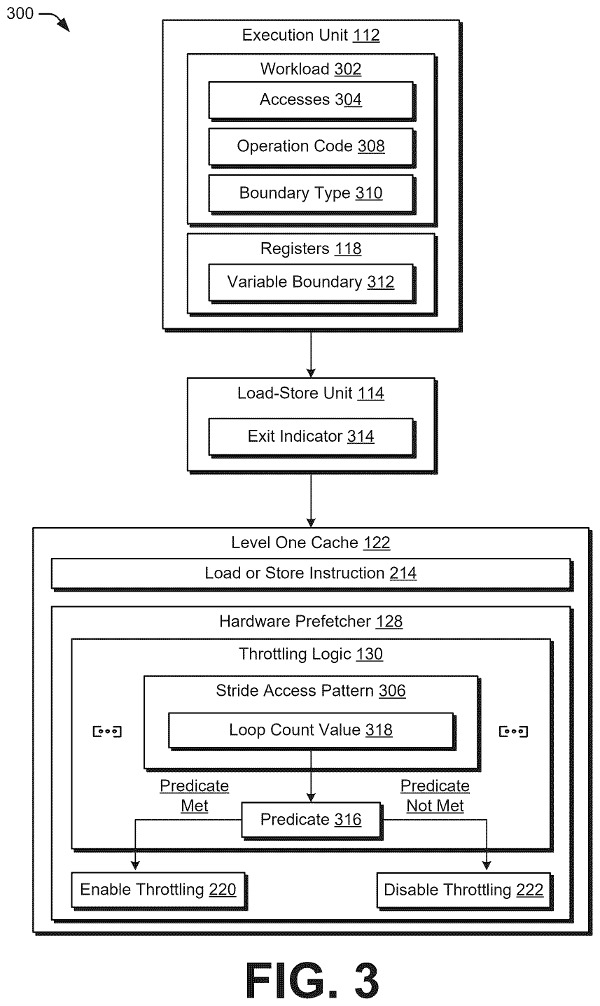

Specifically, the described techniques utilize an instruction set architecture (ISA)-based interface to allow the software's operation code to indicate the boundary hints 132. Based on different constraints of stride access patterns, this document describes two implementations of this interface: a first implementation based directly on memory address constraints, which is described in greater detail with respect to FIG. 2, and a second implementation based on induction variable constraints, which is described in greater detail with respect to FIG. 3. Both approaches provide boundary guidance to the hardware prefetcher 128 to avoid excess prefetches while enabling the hardware prefetcher 128 to maintain full flexibility in executing prefetching logic.

FIG. 2 depicts a non-limiting example 200 in which throttling logic uses software-provided boundary hints to throttle prefetch requests issued by a hardware prefetcher of a level one cache. As shown, the example 200 includes an execution unit 112, a load-store unit 114, registers 118, a level one cache 122, a hardware prefetcher 128, and the throttling logic 130 of FIG. 1.

In accordance with the described techniques, the execution unit 112 processes a workload 202, which includes accesses 204 to the level one cache 122. The accesses 204 include access requests issued by the load-store units 114 that access the level one cache 122. Further, a load request accesses the level one cache 122 regardless of whether the data requested is present in the level one cache 122, e.g., regardless of whether the load request results in a cache hit or a cache miss.

The throttling logic 130 is configured to monitor these accesses 204 to identify stride access patterns 206 in the accessed memory addresses. A stride access pattern 206 refers to a sequence of memory addresses accessed with a fixed distance between them, with the distance being referred to as the “stride” or “stride value.” An induction variable is a loop counter variable that may control the memory address calculation with a derived stride value. In other words, the induction variable may control iteration through memory locations with a specific calculable stride. Accordingly, stride access patterns 206 indicate a repetitive and consistent pattern (e.g., as part of an arithmetic loop) in accessing data in memory. For example, the throttling logic 130 measures a degree of striding in the accesses 204 exhibited by the workload in the level one cache 122 to set or update prefetching routines. In one or more implementations, the throttling logic 130 samples the accesses 204 until the stride access patterns 206 are identified. In many instances, the workload 202 includes multiple stride access patterns 206 associated with the accesses 204.

The workload 202 also includes operation code 208 or “opcode” that instructs the execution unit 112 on the boundary hints 132 to provide the throttling logic 130. Generally, the operation code includes load and store operations that the execution unit 112 recognizes as load or store instructions for the accesses 204. In the illustrated example 200, the operation code 208 specifies a boundary type 210 for the boundary conditions to be included in the boundary hints 132. For example, a “less than” condition instructs the throttling logic 130 to allow prefetch requests with a memory address less than the specified memory address. On other hand, a “greater than” condition instructs the throttling logic 130 to allow prefetch requests with a memory address greater than the specified memory address.

In the illustrated example 200, the registers 118 include one or more architected registers. The architected registers represent the set of registers that programmers can directly interact with using instructions defined in the instruction set architecture (ISA). Here, an architected register of registers 118 determines or calculates the boundary address 212 of the boundary hint 132 for a particular load or store instruction within a loop. The load-store unit 114 then identifies a target indicator 214 for the boundary hint 132. The target indicator 214 represents a program counter (PC) offset specifying the load or store instruction counter on which to apply the boundary condition or predicate 216. In other words, the predicate 216 identifies the boundary type, the boundary address 212, and the target indicator 214 for which counter to apply the boundary condition. In contrast, instructions to clear the predicate 216 require a clear instruction within the operation code 208 and the target indicator 214.

The operation code 208 sets and clears the predicates 216, which act as prefetch constraints on individual access instructions (e.g., load or store instructions). Setting and clearing the predicates 216 is necessary because complex loops within the workload 202 may have multiple entry and exit points, and a previously set predicate may no longer apply when a loop is re-entered from a different entry point. The operation code 208 generally sets and clears the predicates 216 before and after invoking a particular loop and is applied to a particular access instruction within the loop.

In accordance with the described techniques, the throttling logic 130 is configured to monitor an accessed memory address 218 as part of prefetching data for a stride access pattern 206 of a respective loop. Once the predicate 216 is set, the throttling logic 130 compares the latest accessed memory address 218 to determine whether to throttle or cease prefetching for that particular loop. Responsive to completing a prefetch request, the throttling logic 130 compares the accessed memory address 218 of the current or next prefetch to the predicate 216. As described above, the predicate 216 is a specific memory address, which, when equaled or exceeded based on the boundary type 210, triggers the hardware prefetcher 128 to throttle the issuance of prefetch requests.

If the accessed memory address 218 is less than (e.g., for a less than boundary type), greater than (e.g., for a greater than boundary type), or equal to (e.g., for both boundary types) the predicate 216 (i.e., “predicate met” in the illustrated example 200), the throttling logic 130 throttles prefetch requests issued by the hardware prefetcher 128, i.e., enable throttling 220. If, however, the memory address 218 is greater than (e.g., for a less than boundary type) or less than (e.g., for a greater than boundary type) the predicate 216 (i.e., “predicate not met” in the illustrated example 200), the throttling logic 130 disables throttling of prefetch requests issued by the hardware prefetcher 128, i.e., disable throttling 222. Accordingly, when throttling is enabled, the throttling logic 130 continues to throttle prefetch requests issued by the hardware prefetcher 128 until the predicate is cleared. Similarly, when throttling is disabled, the throttling remains disabled (e.g., the hardware prefetcher 128 issues prefetch requests without restriction) until the accessed memory address 218 meets or exceeds the predicate 216.

In sum, the described techniques use boundary hints 132 in software associated with workloads 202 to make throttling decisions. The boundary hints 132 are translated into predicates 216 to determine whether to enable or disable prefetch throttling. The advantage of the approach illustrated in FIG. 2 is that it does not rely on loop counts being known (even via dynamically calculable expressions) at compile time. Instead, software associated with workload 202 can use algorithmic metadata to specify boundary conditions for array-based accesses using indices or pointers, thus using memory allocation knowledge to apply conservative constraints on speculative data accesses made by prefetchers. The described approach is well-suited for highly optimized data structure libraries or advanced compiler optimizations.

Further, although not depicted, the throttling logic 130 is duplicated in the level one caches 122 of the other cores of the multi-core processor 104 in one or more implementations, and without utilizing additional hardware to coordinate between the multiple cores. This is possible because the throttling logic 130 of a respective core of the processor 104 detects that a workload is exhibiting a stride access pattern in the level one cache 122 based solely on the accesses 204 to the level one cache 122 of the respective core, i.e., the stride access pattern detection and throttling decision of the throttling logic 130 of the respective core is independent and orthogonal of the striding behavior exhibited in the caches of different cores of the processor 104. As previously mentioned, the described techniques are extendable to cache systems 116 with differing numbers of caches and hierarchical structures. Indeed, the throttling logic 130 detects the striding behavior of a workload in accordance with the described techniques by monitoring accesses 204 to any cache level of the cache system 116.

FIG. 3 depicts another non-limiting example 300 in which throttling logic uses software-provided boundary hints to throttle prefetch requests issued by a hardware prefetcher of a level one cache. As shown, the example 300 includes an execution unit 112, a load-store unit 114, registers 118, a level one cache 122, a hardware prefetcher 128, and the throttling logic 130 of FIG. 1.

Similar to example 200 of FIG. 2, the execution unit 112 processes a workload 302, which includes accesses 304 to the level one cache 122. The accesses 304 include access requests issued by the load-store units 114 that access the level one cache 122. The throttling logic 130 is configured to monitor these accesses 304 to identify stride access patterns 306 in the accessed memory addresses.

The workload 302 also includes operation code 308 that instructs the execution unit 112 on the boundary hints 132 to provide the throttling logic 130. In the illustrated example 300, the operation code 308 specifies a boundary type 310 for the boundary conditions to be included in the boundary hints 132. The boundary type 310 is similar to the boundary type 210 of FIG. 2. For example, a “less than” condition instructs the throttling logic 130 to allow prefetch requests with a memory address less than the specified memory address. On other hand, a “greater than” condition instructs the throttling logic 130 to allow prefetch requests with a memory address greater than the specified memory address.

In the illustrated example 300, the registers 118 include one or more architected registers. Here, an architected register of registers 118 determines or calculates a variable boundary 312 for the boundary hint 132. The variable boundary 312 is associated with an induction variable used by one or more access request sets in an arithmetically bounded loop. Based on the use of the induction variable, the software calculates the total number of loop iterations, which is stored as the boundary hint 132. In other words, prefetch constraints are determined for each access instruction (e.g., load or store requests) in a particular loop that relies on a particular induction variable. In this way, a single boundary hint 132 can apply to multiple access instructions within a single loop, and the loop count is not required to be known at compile time.

The processor front end then identifies an exit indicator 314 for the boundary hint 132. The exit indicator 314 represents a PC offset specifying the PC of the loop exit branch instruction. The exit indicator 314 determines which load-store instructions are contained in the loop associated with the stride access pattern 306 and are subject to the boundary condition. This information is passed to the load-store unit 114 as instructions flow through the processor.

In combination, a predicate 316 identifies the boundary type 310, the variable boundary 312, and the exit indicator 314. For each load-store instruction, the predicate 316 calculates accessible addresses based on the first address accessed, the learned stride of the stride access pattern 306, and variable boundary 312 of the loop count. The predicate 316 applies to each access 304 after the execution of the boundary condition instruction, up until the exit indicator 314 is executed and the loop is exited.

During prefetch generation for predicated accesses 304, the value of the variable boundary 312 is used as the boundary for the predicate 316. The hardware prefetcher 128 uses this loop count boundary to predicate and filter associated prefetches with a loop count value 318. For complex loops with multiple exit locations, separate predicate clear instructions are used to target the metadata instructions to cover all exits.

In accordance with the described techniques, the throttling logic 130 is configured to monitor the loop count value 318 as part of prefetching data for a stride access pattern 306 of a respective loop. Once the predicate 316 is set, the throttling logic 130 compares the loop count value 318 or the associated memory address to determine whether to throttle or cease prefetching for that particular loop. Responsive to completing a prefetch request, the throttling logic 130 compares the loop count value 318 of the current or next prefetch to the predicate 316. As described above, the predicate 316 is a specific memory address or loop count value 318, which, when equaled or exceeded based on the boundary type 310, triggers the hardware prefetcher 128 to throttle the issuance of prefetch requests.

If the loop count value 318 is less than (e.g., for a less than boundary type), greater than (e.g., for a greater than boundary type), or equal to (e.g., for both boundary types) the predicate 316 (i.e., “predicate met” in the illustrated example 200), the throttling logic 130 throttles prefetch requests issued by the hardware prefetcher 128, i.e., enable throttling 220. If, however, the loop count value 318 is greater than (e.g., for a less than boundary type) or less than (e.g., for a greater than boundary type) the predicate 316 (i.e., “predicate not met” in the illustrated example 200), the throttling logic 130 disables throttling of prefetch requests issued by the hardware prefetcher 128, i.e., disable throttling 222. Accordingly, when throttling is enabled, the throttling logic 130 continues to throttle prefetch requests issued by the hardware prefetcher 128 until the predicate 316 is cleared. Similarly, when throttling is disabled, the throttling remains disabled (e.g., the hardware prefetcher 128 issues prefetch requests without restriction) until the loop count value 318 meets or exceeds the predicate 316. The prefetching techniques of example 300 are well suited to be implemented in compilers as a separate pass, or potentially automatically applied directly in hardware if loop detection logic is present.

In scenarios of branch mispredictions within inner loops triggered with a predicate 316 in active scope, the branch mispredictions within those loops do not impact the correctness of the predicate 316 because the predicate 316 is set before these loops begin. In other scenarios, prefetches from both bad-path and correct path accesses 304 may get throttled, but any memory addresses appearing in the correct path do not negatively impact a correctly defined boundary condition. In contrast, branch mispredictions triggered in outer loops that change the boundary condition of the inner loop may cause incorrect boundary conditions to be applied along the bad-path execution of the inner loop. If a boundary condition is applied using data from bad-path execution, then until the mispredicted branch is resolved, prefetches for bad path addresses are throttled. Once the branch misprediction in the outer loop is resolved, the boundary condition will be corrected, and throttling can resume in the inner loop as before.

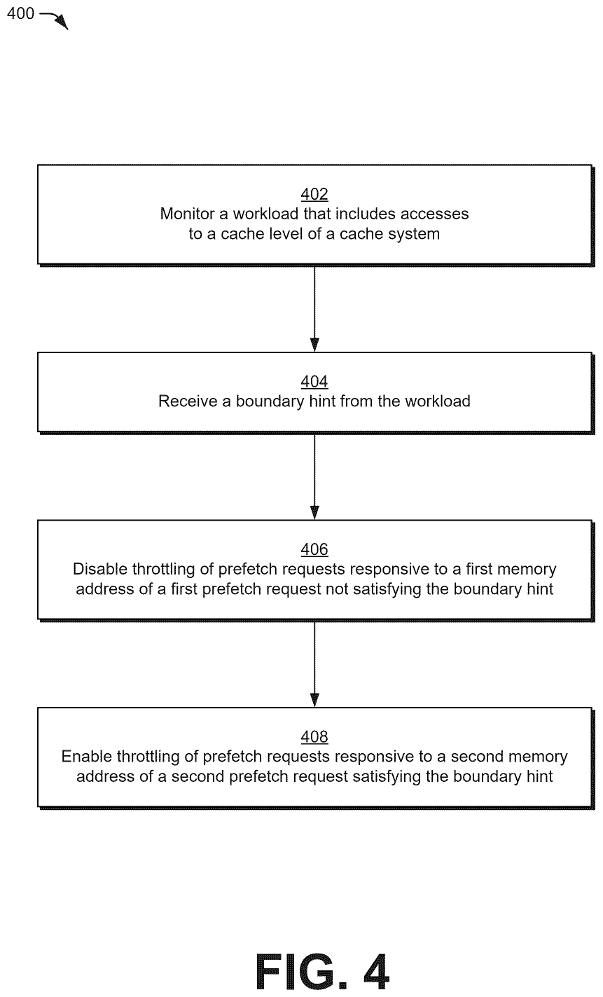

FIG. 4 depicts a procedure 400 in an example implementation of software-guided prefetch throttling based on memory region boundaries. In the procedure 400, a workload is monitored. The workload includes memory accesses to a cache level of a cache system (block 402). By way of example, the throttling logic 130 monitors accesses 204 of a workload 202 to the level one cache 122.

A hardware prefetcher associated with the cache level receives a boundary from or associated with the workload (block 404). By way of example, the throttling logic 130 receives the boundary hint 132 in association with a stride access pattern of the workload 202. In one implementation, the boundary hint 132 includes a boundary type 210 for the boundary condition, a boundary address 212 for the boundary condition, and a target indicator 214 identifying the loop count value associated with the stride access pattern. In another implementation, the boundary hint 132 includes a boundary type 310 for the boundary condition, a variable boundary 312 based on a value of a loop count associated with the stride access pattern, and an exit indicator 314 indicating a memory address of an exit from the stride access pattern.

Throttling of prefetch requests issued by a hardware prefetcher associated with the cache level is disabled responsive to a first memory address of a first prefetch request not satisfying the boundary hint (block 406). Throttling of prefetch requests issued by the hardware prefetcher associated with the cache level is enabled responsive to a second memory address of a second prefetch request satisfying the boundary hint (block 408). By way of example, the throttling logic 130 monitors the accessed memory addresses or loop count associated with prefetch requests to determine whether the boundary condition in the boundary hint 132 has been satisfied.

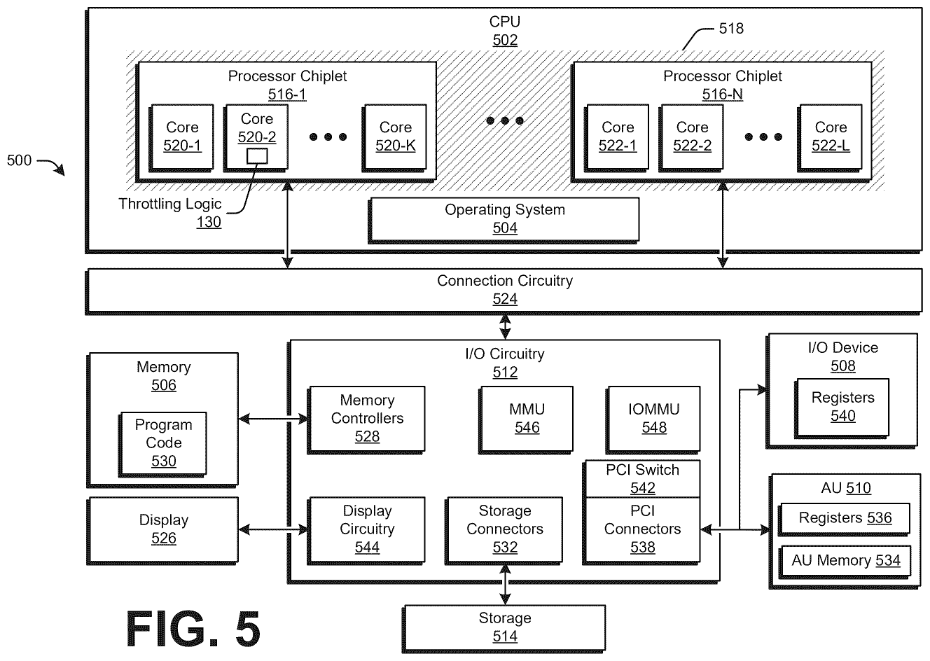

FIG. 5 is a block diagram of a processing system configured to execute one or more applications in accordance with one or more implementations. In particular, FIG. 5 includes a processing system 500 configured to execute one or more applications, such as computing applications (e.g., machine-learning applications, neural network applications, high-performance computing applications, databasing applications, gaming applications), graphics applications, and the like. Examples of devices in which the processing system 500 is implemented include but are not limited to a server computer, personal computer (e.g., desktop or tower computer), smartphone or another wireless phone, tablet or phablet computer, notebook computer, laptop computer, wearable device (e.g., smartwatch, augmented reality headset or device, virtual reality headset or device), entertainment device (e.g., gaming console, portable gaming device, streaming media player, digital video recorder, music or another audio playback device, television, set-top box), Internet of Things (IoT) device, automotive computer or computer for another type of vehicle, networking device, medical device or system, and other computing devices or systems.

In the illustrated example, the processing system 500 includes a central processing unit (CPU) 502. In one or more implementations, the CPU 502 is configured to run an operating system (OS) 504 that manages the execution of applications. For example, the OS 504 is configured to schedule the execution of tasks (e.g., instructions) for applications, allocate portions of resources (e.g., system memory 506, CPU 502, input/output (I/O) device 508, accelerator unit (AU) 510, storage 514) for the execution of tasks for the applications, provide an interface to I/O devices (e.g., I/O device 508) for the applications, or any combination thereof.

The CPU 502 includes one or more processor chiplets 516, which are communicatively coupled by a data fabric 518 in one or more implementations. Each processor chiplet 516, for example, includes one or more processor cores 520, 522 configured to execute one or more series of instructions concurrently, also referred to herein as “threads” or workloads 202, for an application. Further, the data fabric 518 communicatively couples each processor chiplet 516-N of the CPU 502 such that each processor core (e.g., processor cores 520) of a first processor chiplet (e.g., 516-1) is communicatively coupled to each processor core (e.g., processor cores 522) of one or more other processor chiplets 516.

Though the example embodiment in FIG. 5 shows a first processor chiplet (516-1) having three processor cores (520-1, 520-2, 520-K) representing a K number of processor cores 522 and a second processor chiplet (516-N) having three processor cores (e.g., 522-1, 522-2, 522-L) representing an L number of processor cores 522, in other implementations (L being an integer number greater than or equal to one), each processor chiplet 516 may have any number of processor cores 520, 522. For example, each processor chiplet 516 can have the same number of processor cores 520, 522 as one or more other processor chiplets 516, a different number of processor cores 520, 522 as one or more other processor chiplets 516, or both.

In this example, the throttling logic 130 is depicted in the core 520-2. In variations, however, the throttling logic 130 is included in and/or is implemented by one or more different components of the processing system 500, such as the other processor cores 520, 522, CPU 502, the AU 510, and so forth. In at least one implementation, the throttling logic 130 or portions thereof is included in at least two of the depicted components of the processing system 500 (e.g., each processor core 520, 522).

Examples of connections that are usable to implement the data fabric 518 include but are not limited to buses (e.g., a data bus, a system, an address bus), interconnects, memory channels, and silicon vias, traces, and planes. Other example connections include optical connections, fiber optic connections, and/or connections or links based on quantum entanglement.

Additionally, within the processing system 500, the CPU 502 is communicatively coupled to an I/O circuitry 512 by a connection circuitry 524. For example, each processor chiplet 516 of the CPU 502 is communicatively coupled to the I/O circuitry 512 by the connection circuitry 524. The connection circuitry 524 includes, for example, one or more data fabrics, buses, buffers, queues, and the like. The I/O circuitry 512 is configured to facilitate communications between two or more components of the processing system 500 such as between the CPU 502, system memory 506, display 526, universal serial bus (USB) devices, peripheral component interconnect (PCI) devices (e.g., I/O device 508, AU 510), storage 514, and the like.

As an example, system memory 506 includes any combination of one or more volatile memories and/or one or more non-volatile memories, examples of which include dynamic random-access memory (DRAM), static random-access memory (SRAM), non-volatile RAM, and the like. To manage access to the system memory 506 by CPU 502, the I/O device 508, the AU 510, and/or any other components, the I/O circuitry 512 includes one or more memory controllers 528. The memory controllers 528, for example, include circuitry configured to manage and fulfill memory access requests issued from the CPU 502, the I/O device 508, the AU 510, or any combination thereof. Examples of such requests include read requests, write requests, fetch requests, pre-fetch requests, or any combination thereof. That is to say, the memory controllers 528 are configured to manage access to the data stored at one or more memory addresses within the system memory 506, such as by CPU 502, I/O device 508, and/or AU 510.

When an application is to be executed by processing system 500, the OS 504 running on the CPU 502 is configured to load at least a portion of program code 530 (e.g., an executable file) associated with the application from, for example, a storage 514 into system memory 506. This storage 514, for example, includes a non-volatile storage such as a flash memory, solid-state memory, hard disk, optical disc, or the like configured to store program code 530 for one or more applications.

To facilitate communication between the storage 514 and other components of processing system 500, the I/O circuitry 512 includes one or more storage connectors 532 (e.g., universal serial bus (USB) connectors, serial AT attachment (SATA) connectors, PCI Express (PCIe) connectors) configured to communicatively couple storage 514 to the I/O circuitry 512 such that I/O circuitry 512 is capable of routing signals to and from the storage 514 to one or more other components of the processing system 500.

In association with executing an application, in one or more scenarios, the CPU 502 is configured to issue one or more instructions (e.g., threads) to be executed for an application to the AU 510. The AU 510 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 510 includes one or more compute units that concurrently execute one or more threads of an application and store data resulting from the execution of these threads in AU memory 534. This AU memory 534, for example, includes any combination of one or more volatile memories and/or non-volatile memories, examples of which include caches, video RAM (VRAM), or the like. In one or more implementations, these compute units are also configured to execute these threads based on the data stored in one or more physical registers 536 of the AU 510.

To facilitate communication between the AU 510 and one or more other components of processing system 500, the I/O circuitry 512 includes or is otherwise connected to one or more connectors, such as PCI connectors 538 (e.g., PCIe connectors) each including circuitry configured to communicatively couple the AU 510 to the I/O circuitry such that the I/O circuitry 512 is capable of routing signals to and from the AU 510 to one or more other components of the processing system 500. Further, the PCIe connectors 538 are configured to communicatively couple the I/O device 508 to the I/O circuitry 512 such that the I/O circuitry 512 is capable of routing signals to and from the I/O device 508 to one or more other components of the processing system 500.

By way of example and not limitation, the I/O device 508 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 508 is configured to execute one or more operations, tasks, instructions, or any combination thereof based on one or more physical registers 540 of the I/O device 508. In one or more implementations, such physical registers 540 are configured to maintain data (e.g., operands, instructions, values, variables) indicating one or more operations, tasks, or instructions to be performed by the I/O device 508.

To manage communication between components of the processing system 500 (e.g., AU 510, I/O device 508) that are connected to PCI connectors 538, and one or more other components of the processing system 500, the I/O circuitry 512 includes PCI switch 542. The PCI switch 542, for example, includes circuitry configured to route packets to and from the components of the processing system 500 connected to the PCI connectors 538 as well as to the other components of the processing system 500. As an example, based on address data indicated in a packet received from a first component (e.g., CPU 502), the PCI switch 542 routes the packet to a corresponding component (e.g., AU 510) connected to the PCI connectors 538.

Based on the processing system 500 executing a graphics application, for instance, the CPU 502, the AU 510, or both are configured to execute one or more instructions (e.g., draw calls) such that a scene including one or more graphics objects is rendered. After rendering such a scene, the processing system 500 stores the scene in the storage 514, displays the scene on the display 526, or both. The display 526, for example, includes a cathode-ray tube (CRT) display, liquid crystal display (LCD), light emitting diode (LED) display, organic light emitting diode (OLED) display, or any combination thereof. To enable the processing system 500 to display a scene on the display 526, the I/O circuitry 512 includes display circuitry 544. The display circuitry 544, for example, includes high-definition multimedia interface (HDMI) connectors, DisplayPort connectors, digital visual interface (DVI) connectors, USB connectors, and the like, each including circuitry configured to communicatively couple the display 526 to the I/O circuitry 512. Additionally or alternatively, the display circuitry 544 includes circuitry configured to manage the display of one or more scenes on the display 526 such as display controllers, buffers, memory, or any combination thereof.

Further, the CPU 502, the AU 510, or both are configured to concurrently run one or more virtual machines (VMs), which are each configured to execute one or more corresponding applications. To manage communications between such VMs and the underlying resources of the processing system 500, such as any one or more components of processing system 500, including the CPU 502, the I/O device 508, the AU 510, and the system memory 506, the I/O circuitry 512 includes memory management unit (MMU) 546 and input-output memory management unit (IOMMU) 548. The MMU 546 includes, for example, circuitry configured to manage memory requests, such as from the CPU 502 to the system memory 506. For example, the MMU 546 is configured to handle memory requests issued from the CPU 502 and associated with a VM running on the CPU 502. These memory requests, for example, request access to read, write, fetch, or pre-fetch data residing at one or more virtual addresses (e.g., guest virtual addresses) each indicating one or more portions (e.g., physical memory addresses) of the system memory 506. Based on receiving a memory request from the CPU 502, the MMU 546 is configured to translate the virtual address indicated in the memory request to a physical address in the system memory 506 and to fulfill the request. The IOMMU 548 includes, for example, circuitry configured to manage memory requests (memory-mapped I/O (MMIO) requests) from the CPU 502 to the I/O device 508, the AU 510, or both, and to manage memory requests (direct memory access (DMA) requests) from the I/O device 508 or the AU 510 to the system memory 506. For example, to access the registers 540 of the I/O device 508, the registers 536 of the AU 510, and/or the AU memory 534, the CPU 502 issues one or more MMIO requests. Such MMIO requests each request access to read, write, fetch, or pre-fetch data residing at one or more virtual addresses (e.g., guest virtual addresses) which each represent at least a portion of the registers 540 of the I/O device 508, the registers 536 of the AU 510, or the AU memory 534, respectively. As another example, to access the system memory 506 without using the CPU 502, the I/O device 508, the AU 510, or both are configured to issue one or more DMA requests. Such DMA requests each request access to read, write, fetch, or pre-fetch data residing at one or more virtual addresses (e.g., device virtual addresses) which each represent at least a portion of the system memory 506. Based on receiving an MMIO request or DMA request, the IOMMU 548 is configured to translate the virtual address indicated in the MMIO or DMA request to a physical address and fulfill the request.

In variations, the processing system 500 can include any combination of the components depicted and described. For example, in at least one variation, the processing system 500 does not include one or more of the components depicted and described in relation to FIG. 5. Additionally or alternatively, in at least one variation, the processing system 500 includes additional and/or different components from those depicted. The 500 is configurable in a variety of ways with different combinations of components in accordance with the described techniques.

It should be understood that many variations are possible based on the disclosure herein. Although features and elements are described above in particular combinations, each feature or element is usable alone without the other features and elements or in various combinations with or without other features and elements.

The various functional units illustrated in the figures and/or described herein (including, where appropriate, the device 102, the processor 104, the memory system 106 having the volatile memory 108 and the non-volatile memory 110, the execution units 112, the load-store units 114, the cache system 116, the hardware prefetcher 128, and the throttling logic 130) are implemented in any of a variety of different manners such as hardware circuitry, software or firmware executing on a programmable processor, or any combination of two or more of hardware, software, and firmware. The methods provided are implemented in any of a variety of devices, such as a general purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A processor, comprising:
prefetching circuitry associated with a cache level of a hierarchy of one or more cache levels, the prefetching circuitry configured to:
receive a boundary hint from a workload of an execution unit that accesses the cache level; and
throttle prefetch requests based on the boundary hint being satisfied.

2. The processor of claim 1, wherein the accesses of the workload include a stride access pattern.

3. The processor of claim 2, wherein the boundary hint includes a boundary type for a boundary condition of the stride access pattern, a boundary address for the boundary condition, and a target indicator identifying a program counter associated with the stride access pattern.

4. The processor of claim 3, wherein the boundary type includes instructions to allow prefetch requests with a memory address less than the boundary address or greater than the boundary address.

5. The processor of claim 3, wherein the processor further includes a register configured to determine the boundary address based on algorithmic metadata associated with the accesses included in one or more operation codes of the processor.

6. The processor of claim 3, wherein the boundary address is specified as an offset to the program counter.

7. The processor of claim 3, wherein the boundary condition is:
set before the workload invokes a loop associated with the stride access pattern; and
cleared after the workload completes the loop.

8. The processor of claim 3, wherein the prefetch requests are throttled in response to a memory address accessed by a prefetch request satisfying the boundary type and the boundary address.

9. The processor of claim 8, wherein the boundary condition is applied to each access instruction of a loop associated with the stride access pattern.

10. The processor of claim 2, wherein the boundary hint includes:
a boundary type for a boundary condition of the stride access pattern;
a variable boundary for the boundary condition based on a value of a loop count associated with the stride access pattern; and
an exit indicator indicating a program counter of an exit from a loop associated with the stride access pattern.

11. The processor of claim 10, wherein the boundary condition is set for each loop associated with the loop count.

12. The processor of claim 11, wherein the boundary condition applies to each access instruction until the boundary condition is satisfied.

13. The processor of claim 10, wherein the prefetch requests are throttled in response to a loop count value associated with a memory address accessed by a prefetch request satisfying the boundary type and the variable boundary.

14. A system, comprising:
a processor including a cache system with a cache level that includes prefetching circuitry, the processor configured to:
execute a workload that accesses the cache level; and
send, to the prefetching circuitry, a boundary hint indicating a prefetching boundary condition for prefetch requests associated with the workload.

15. The system of claim 14, wherein the boundary hint is generated from operation code associated with the workload.

16. The system of claim 15, wherein the boundary hint is automatically determined by a compiler when compiling software associated with the workload.

17. The system of claim 14, wherein the accesses of the workload include a stride access pattern.

18. The system of claim 17, wherein the boundary hint includes a boundary type for a boundary condition of the stride access pattern, a boundary address for the boundary condition, and a target indicator identifying a program counter associated with the stride access pattern.

19. The system of claim 17, wherein the boundary hint includes:
a boundary type for a boundary condition of the stride access pattern;
a variable boundary for the boundary condition based on a value of a loop count associated with the stride access pattern; and
an exit indicator indicating a program counter of an exit from a loop associated with the stride access pattern.

20. A method comprising:
receiving, by a hardware prefetcher associated with a cache level of a hierarchy of one or more cache levels, a boundary hint from a workload of an execution unit that accesses the cache level;
disabling, by the hardware prefetcher, throttling of prefetch requests responsive to a first memory address of a first prefetch request associated with the workload not satisfying the boundary hint; and
enabling, by the hardware prefetcher, the throttling of the prefetch requests responsive to a second memory address of a second prefetch request associated with the workload satisfying the boundary hint.
